(19) United States
(12) Patent Application Publication
(10) Pub. No.: US 2026/0132666 A1
(43) Pub. Date: May 14, 2026

(54) VEHICLE DOOR OPENING AND CLOSING DEVICE

(71) Applicant: AISIN CORPORATION, Kariya (JP)

(72) Inventors: Yusuke KAJINO, Kariya-shi (JP); Yosuke KAJI, Kariya-shi (JP)

(73) Assignee: AISIN CORPORATION, Kariya (JP)

(21) Appl. No.: 19/376,396

(22) Filed: Oct. 31, 2025

(30) Foreign Application Priority Data
Nov. 11, 2024 (JP) 2024-196613
Sep. 18, 2025 (JP) 2025-155193

(51) Int. Cl. E05F 15/627; B60J 5/04

(52) U.S. Cl. CPC E05F 15/627; B60J 5/0472; E05Y 2201/626; E05Y 2201/664; E05Y 2201/672; E05Y 2900/531

(57) ABSTRACT

Provided is a vehicle door opening and closing device that can increase a degree of freedom in disposing a door drive unit. The door opening and closing device includes a door drive unit that provides a link arm with a torque for rotating the link arm relative to a vehicle body. The door drive unit includes: a drive drum to be driven by an electric motor; a driven drum to be disposed at a distance from the drive drum; a cable that is wound onto the drive drum and the driven drum and transmit power from the drive drum to the driven drum; and a transmission unit that provides the link arm with the torque, based on power transmitted from the driven drum.

### CROSS REFERENCE TO RELATED APPLICATIONS

This application is based on and claims priority under 35 U.S.C. § 119 to Japanese Patent Application 2024-196613 filed on Nov. 11, 2024 and Japanese Patent Application 2025-155193 filed on Sep. 18, 2025, the entire content of each of which is incorporated herein by reference.

### TECHNICAL FIELD

This disclosure generally relates to a vehicle door opening and closing device.

### BACKGROUND DISCUSSION

JP2022-92327A (Reference 1) describes a vehicle door opening and closing device that connects a vehicle and a door. The vehicle door opening and closing device includes: a first link arm and a second link arm each having a proximal portion rotatably connected to a vehicle body and a distal portion rotatably connected to the door; and a door drive unit that provides the first link arm with power for opening and closing the door.

Axes of rotation of the first link arm and the second link arm relative to the vehicle body extend in a vertical direction and axes of rotation of the first link arm and the second link arm relative to the door extend in a vertical direction. The vehicle body, the door, the first link arm, and the second link arm constitute a four-bar linkage. The door drive unit provides the first link arm with a torque for rotating the first link arm about an axis relative to the vehicle body. The door drive unit rotates the first link arm and as a result, opens and closes the door.

In the vehicle door opening and closing device as described above, the door drive unit is mounted near the proximal portion of the first link arm. Therefore, for the vehicle door opening and closing device as described above, it is desired to increase a degree of freedom in disposing the door drive unit.

A need thus exists for a vehicle door opening and closing device, which is not susceptible to the drawback mentioned above.

### SUMMARY

A door opening and closing device to solve the above-described problem is a vehicle door opening and closing device to be applied to a vehicle including a vehicle body having a door opening and a door that opens and closes the door opening and includes: a link arm with a proximal portion to be rotatably connected to the vehicle body and a distal portion to be rotatably connected to the door; and a door drive unit that provides the link arm with a torque for rotating the link arm relative to the vehicle body. The door drive unit includes: a drive drum to be driven by an electric motor; a driven drum to be disposed at a distance from the drive drum; a cable that is wound onto the drive drum and the driven drum and transmits power from the drive drum to the driven drum; and a transmission unit that provides the link arm with the torque, based on power transmitted from the driven drum.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a perspective view illustrating a schematic configuration of a vehicle including a door opening and closing device;

FIG. 2 is a perspective view illustrating the schematic configuration of the vehicle illustrated in FIG. 1;

FIG. 3 is a side view of the vehicle illustrated in FIG. 1;

FIG. 4 is a perspective view of the door opening and closing device illustrated in FIG. 1;

FIG. 5 is a perspective view of the door opening and closing device illustrated in FIG. 1;

FIG. 6 is an exploded perspective view of the door opening and closing device illustrated in FIG. 1;

FIG. 7 is an exploded perspective view of the door opening and closing device illustrated in FIG. 1;

FIG. 8 is an exploded perspective view of the door opening and closing device illustrated in FIG. 1;

FIG. 9 is an exploded perspective view of a driven drum of the door opening and closing device illustrated in FIG. 1;

FIG. 10 is a cross-sectional view of the driven drum of the door opening and closing device illustrated in FIG. 1;

FIG. 11 is a cross-sectional view of the driven drum taken along a line 11-11 in FIG. 10;

FIG. 12 is a cross-sectional view of the driven drum taken along a line 12-12 in FIG. 10;

FIG. 13 is a perspective view in which a structure related to power transmission of the door opening and closing device illustrated in FIG. 1 is taken out;

FIG. 14 is a perspective view in which the structure related to power transmission of the door opening and closing device illustrated in FIG. 1 is taken out;

FIG. 15 is a partial plan view of the door opening and closing device illustrated in FIG. 1;

FIG. 16 is a perspective view of a door opening and closing device of a variation example;

FIG. 17 is an exploded partial perspective view of the door opening and closing device illustrated in FIG. 16; and

FIG. 18 is a partial plan view of the door opening and closing device illustrated in FIG. 16.

### DETAILED DESCRIPTION

An embodiment of a vehicle including a vehicle door opening and closing device (hereinafter referred to as a “door opening and closing device”) will be explained.

### Configuration of The Present Embodiment

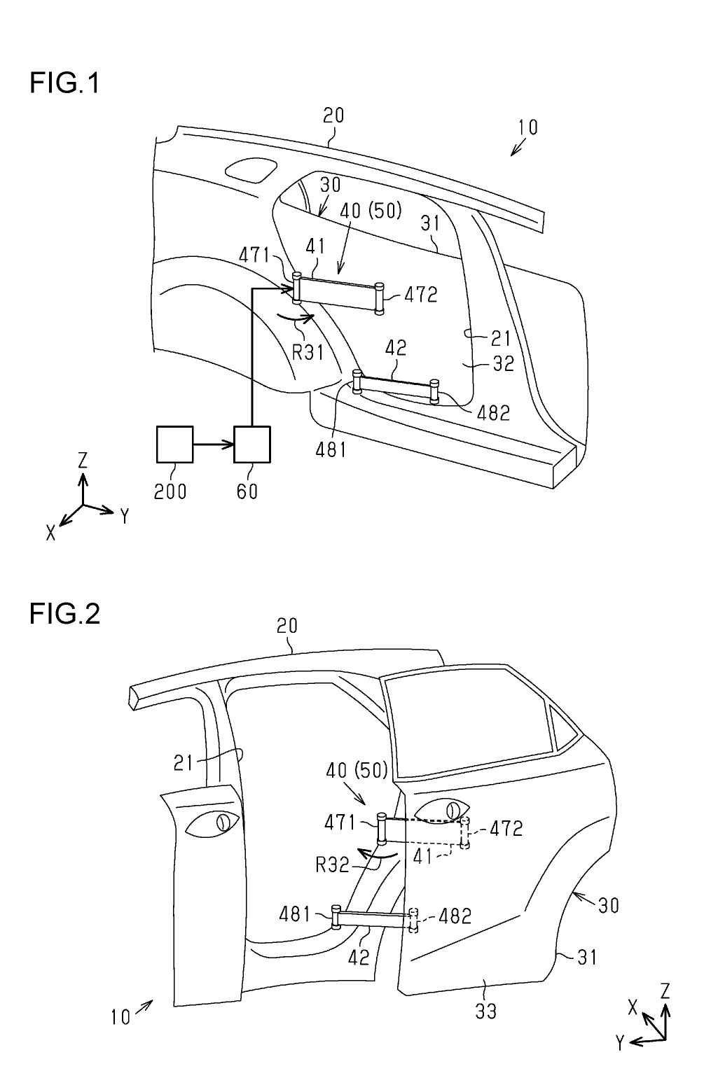

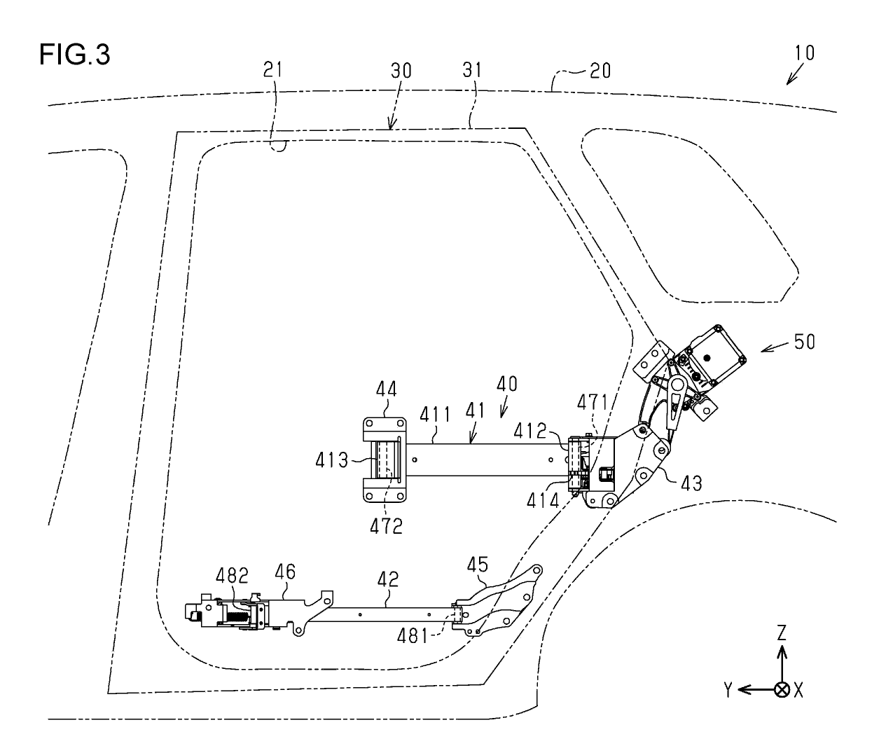

As illustrated in FIG. 1 to FIG. 3, a vehicle 10 includes a vehicle body 20, a door 30, a door opening and closing device 40, and a controller 200.

In the description below, a width direction of the vehicle 10, a front-back direction of the vehicle 10, and a vertical direction of the vehicle 10 are respectively referred to as the width direction, the front-back direction, and the vertical direction. In the figure, the width direction is a direction in which an X axis extends, the front-back direction is a direction in which a Y axis extends, and the vertical direction is a direction in which a Z axis extends. In the width direction, a direction toward the center of the vehicle 10 is referred to as “inward” while a direction away from the center of the vehicle 10 is referred to as “outward”.

### Vehicle body 20

The vehicle body 20 includes a door opening 21. The door opening 21 is provided in a side surface in the width direction of the vehicle body 20. The door opening 21 is a region through which a user passes when getting on or off the vehicle 10 into or from a back seat. Although illustration is omitted, the vehicle body 20 preferably includes a striker that binds the door 30.

### Door 30

The door 30 includes a door main unit 31. The door main unit 31 includes an inner panel 32 and an outer panel 33. The inner panel 32 and the outer panel 33 are panels formed according to a shape of the door opening 21. The inner panel 32 serves as a section of the door main unit 31 facing inward of the vehicle 10 and the outer panel 33 serves as a section of the door main unit 31 facing outward of the vehicle 10. The inner panel 32 and the outer panel 33 are joined by means of welding or the like.

### Door Opening and Closing Device 40

The door opening and closing device 40 includes a first link arm 41, a second link arm 42, a first vehicle-body side bracket 43, a first door side bracket 44, a second vehicle-body side bracket 45, and a second door side bracket 46. The door opening and closing device 40 also includes two first support shafts 471, 472, two second support shafts 481, 482, and a door drive unit 50.

### First Link Arm 41 and First Brackets 43, 44

The first link arm 41 is an arm that defines an open-close trajectory of the door 30 and supports a weight of the door 30.

Therefore, flexural rigidity of the first link arm 41 is configured to be higher than that of the second link arm 42. The first link arm 41 includes an arm main unit 411, a proximal side connecting section 412, a distal side connecting section 413, and an output gear 414.

The arm main unit 411 is rod-shaped. The arm main unit 411 constitutes a majority of the first link arm 41. The proximal side connecting section 412 constitutes a proximal portion of the first link arm 41. The distal side connecting section 413 constitutes a distal portion of the first link arm 41. The proximal side connecting section 412 and the distal side connecting section 413 are columnar. A height direction of the proximal side connecting section 412 and a height direction of the distal side connecting section 413 are both vertical. The output gear 414 is a sector gear. The output gear 414 is fixed to the proximal side connecting section 412. An axis of the output gear 414 extends in the vertical direction. When the output gear 414 rotates, the output gear 414 rotates in conjunction with the arm main unit 411.

The first vehicle-body side bracket 43 is, for example, constructed by joining a plurality of metallic plates to be stamped. The first vehicle-body side bracket 43 supports the first support shaft 471. An axis of the first support shaft 471 extends in the vertical direction. The first vehicle-body side bracket 43 rotatably supports the proximal side connecting section 412 of the first link arm 41 through the first support shaft 471. In this case, the first support shaft 471 penetrates through the proximal side connecting section 412 of the first link arm 41 in the vertical direction. Consequently, the first link arm 41 is rotatable about the axis of the first support shaft 471 relative to the first vehicle-body side bracket 43. The axis of the first support shaft 471 coincides with the axis of the output gear 414. The first vehicle-body side bracket 43 is fixed to the vehicle body 20 with a fastening member. In the present embodiment, the fastening member may be a screw, a bolt and a nut, or a rivet.

The first door side bracket 44 is, for example, formed by stamping a metallic plate. The first door side bracket 44 supports the first support shaft 472. An axis of the first support shaft 472 extends in the vertical direction. The first door side bracket 44 rotatably supports the distal side connecting section 413 of the first link arm 41 through the first support shaft 472. Consequently, the first link arm 41 is rotatable about the axis of the first support shaft 472 relative to the first door side bracket 44. The first door side bracket 44 is fixed to the door 30 with a fastening member.

### Second Link Arm 42 and Second Brackets 45, 46

The second link arm 42 is an arm that defines the open-close trajectory of the door 30. One end in a longitudinal direction of the second link arm 42 is a proximal portion and the other end in the longitudinal direction of the second link arm 42 is a distal portion. The second link arm 42 may be configured in such a way that a length of the second link arm 42 in the longitudinal direction is adjustable. In this case, the second link arm 42 is preferably biased by a coil spring or the like in a direction in which the second link arm 42 is shrunk.

The second vehicle-body side bracket 45 is, for example, formed by stamping a metallic plate. The second vehicle-body side bracket 45 supports the second support shaft 481. An axis of the second support shaft 481 extends in the vertical direction. The second vehicle-body side bracket 45 rotatably supports the proximal portion of the second link arm 42 through the second support shaft 481. Consequently, the second link arm 42 is rotatable about the axis of the second support shaft 481 relative to the second vehicle-body side bracket 45. The second vehicle-body side bracket 45 is fixed to the vehicle body 20 with a fastening member.

The second door side bracket 46 is, for example, formed by stamping a metallic plate. The second door side bracket 46 supports the second support shaft 482. An axis of the second support shaft 482 extends in the vertical direction. The second door side bracket 46 rotatably supports the distal portion of the second link arm 42 through the second support shaft 482. Consequently, the second link arm 42 is rotatable about the axis of the second support shaft 482 relative to the second door side bracket 46. The second door side bracket 46 is fixed to the door 30 with a fastening member.

### Door Drive Unit 50

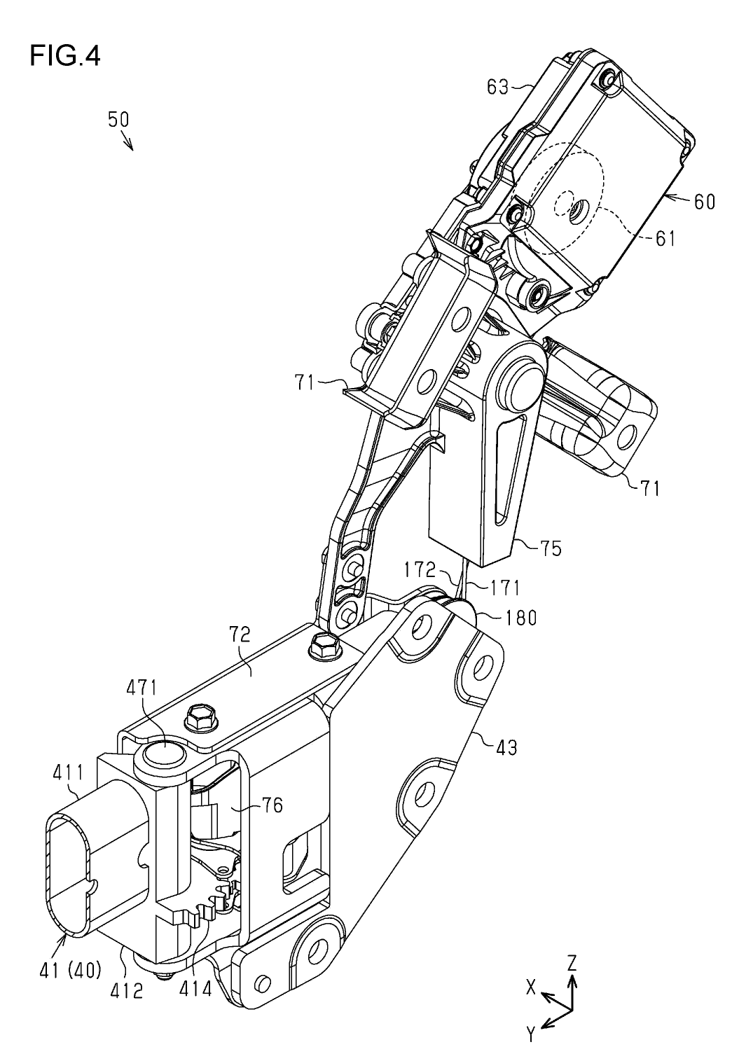

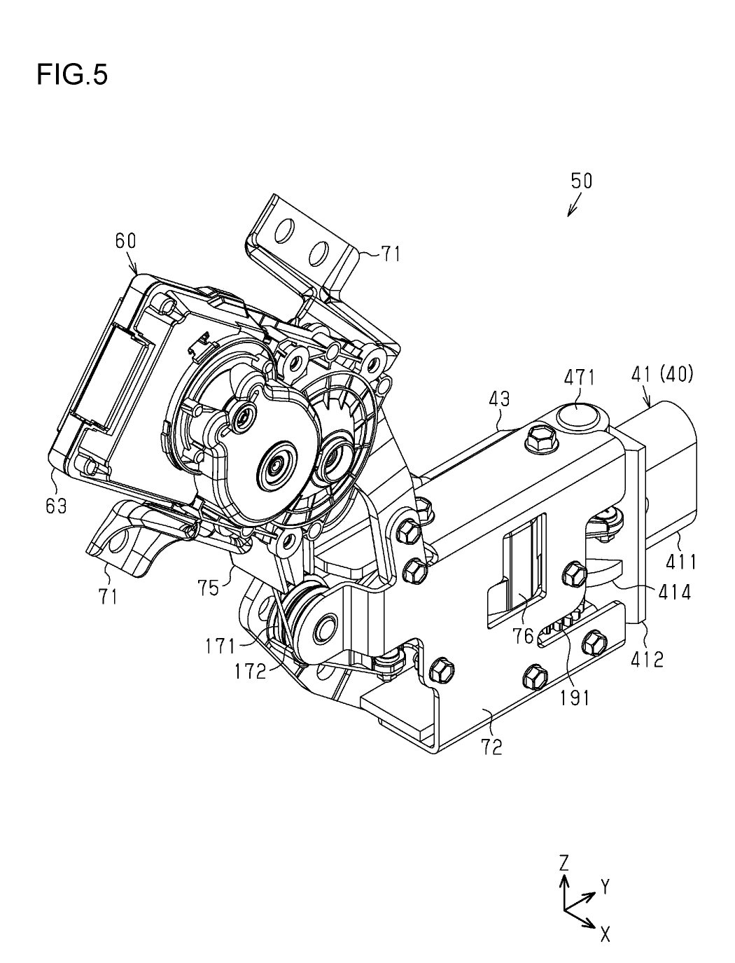

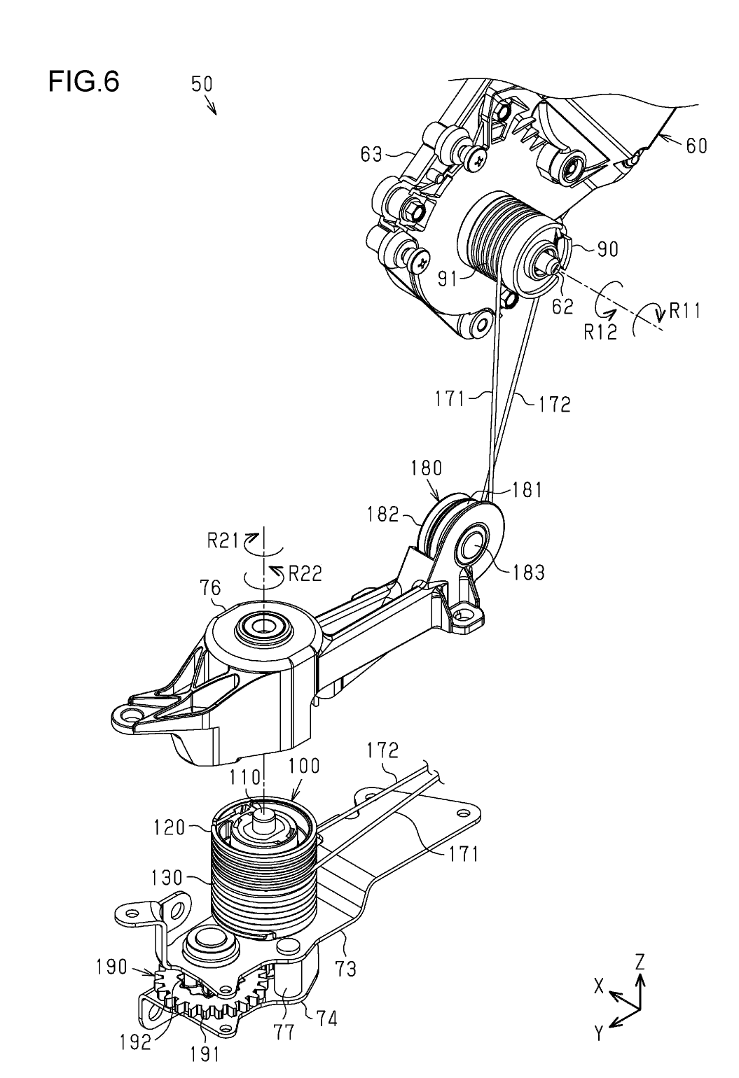

As illustrated in FIG. 4 and FIG. 5, the door drive unit 50 includes an actuator 60, an actuator bracket 71, a base 72, a first cover 75, and a second cover 76. As illustrated in FIG. 6 to FIG. 8, the door drive unit 50 includes a first support plate 73, a second support plate 74, two connecting shafts 77, a drive drum 90, a driven drum 100, two cables 171, 172, an intermediate pulley 180, and a transmission unit 190.

### Actuator 60

The actuator 60 is a drive source for opening and closing the door 30. The actuator 60 includes, as illustrated in FIG. 4 to FIG. 6, an electric motor 61, an output shaft 62, and a case 63. The actuator 60 preferably includes a transmission mechanism for transmitting power from the electric motor 61 to the output shaft 62. The case 63 is box-shaped. The case 63 has a rectangular shape when viewed in the width direction. The case 63 accommodates the electric motor 61. The actuator 60 switches a rotation direction of the output shaft 62 by changing a drive mode of the electric motor 61. In this manner, the output shaft 62 of the actuator 60 rotates in a first driving direction R11 and in a second driving direction R12, which is a direction opposite to the first driving direction R11.

### Actuator Bracket 71 and Base 72

The actuator bracket 71 (which may be referred to as the “ACT bracket 71” hereinafter) is a component for fixing the actuator 60 to the vehicle body 20. The ACT bracket 71 is preferably formed of a material having high rigidity such as metal. The base 72 is an object onto which component parts of the door opening and closing device 40 are assembled. The base 72 is preferably formed of a material having high rigidity such as metal. The base 72 is fixed to the first vehicle-body side bracket 43 with a fastening member.

### Support Plate 73, 74

As illustrated in FIG. 6 to FIG. 8, the first support plate 73 and the second support plate 74 are formed, for example, by stamping a metallic plate. The first support plate 73 and the second support plate 74 are located at a distance in the vertical direction. The first support plate 73 and the second support plate 74 are connected in the vertical direction with two connecting shafts 77. The first support plate 73 and the second support plate 74 are fastened to the base 72 with a fastening member.

### Cover 75, 76

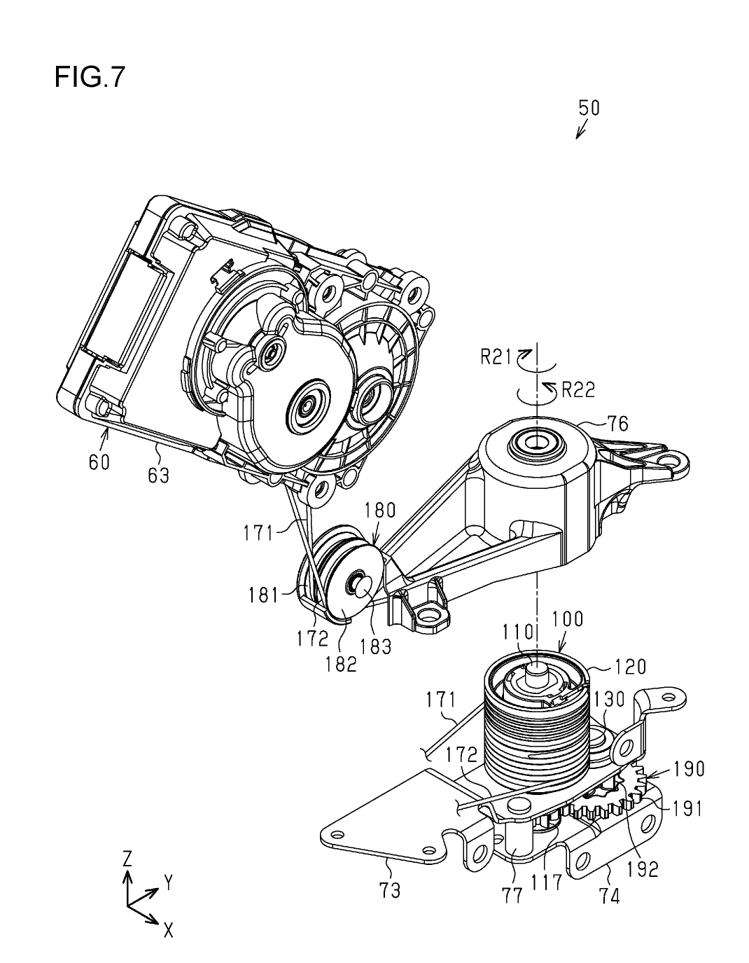

As illustrated in FIG. 4, the first cover 75 is a member for covering the drive drum 90 and part of the cables 171, 172. The first cover 75 is fixed to the ACT bracket 71 with a fastening member together with the actuator 60. The first cover 75 is also fixed to the base 72 with a fastening member. As illustrated in FIG. 6 and FIG. 7, the second cover 76 is a member for covering the driven drum 100 and part of the cables 171, 172. The second cover 76 is fixed to the first support plate 73 with a fastening member.

### Drive Drum 90

As illustrated in FIG. 6, the drive drum 90 is cylindrical. The drive drum 90 includes a helical guide groove 91. The guide groove 91 is provided on an outer circumferential surface of the drive drum 90. The drive drum 90 is fixed to the output shaft 62 of the actuator 60. In other words, an axis of rotation of the drive drum 90 coincides with an axis of rotation of the output shaft 62 of the actuator 60.

The drive drum 90 is rotatable in the first driving direction R11 and in the second driving direction R12 in conjunction with the output shaft 62 of the actuator 60.

### Components of Driven Drum 100

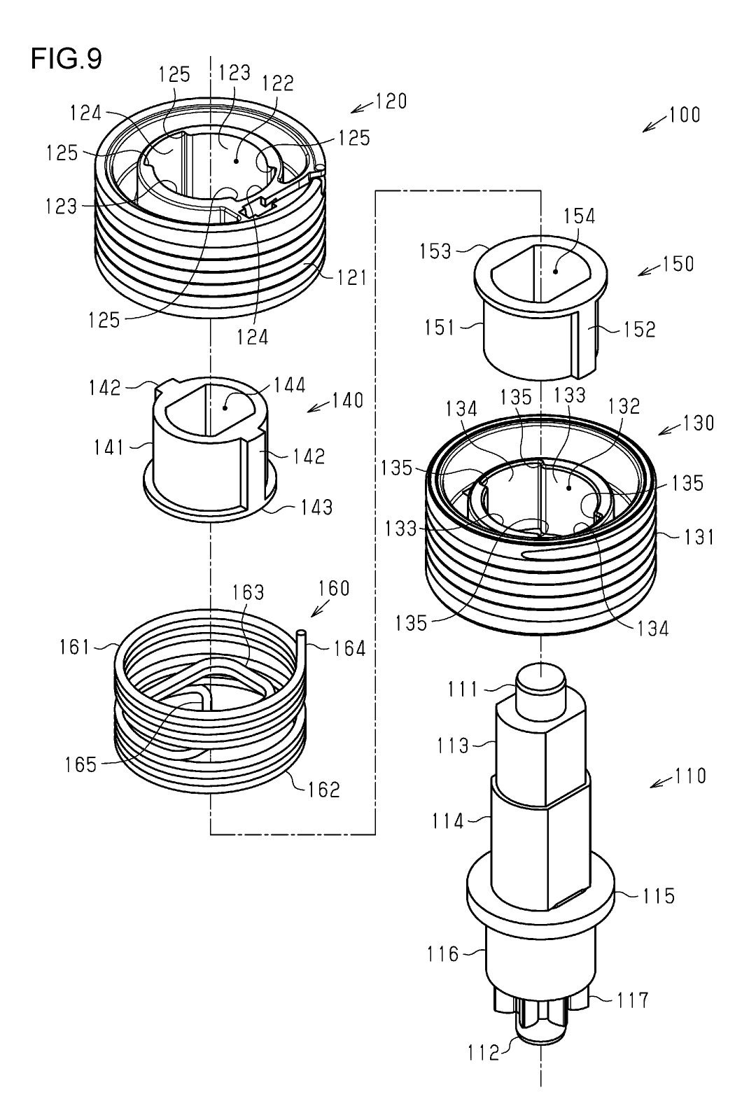

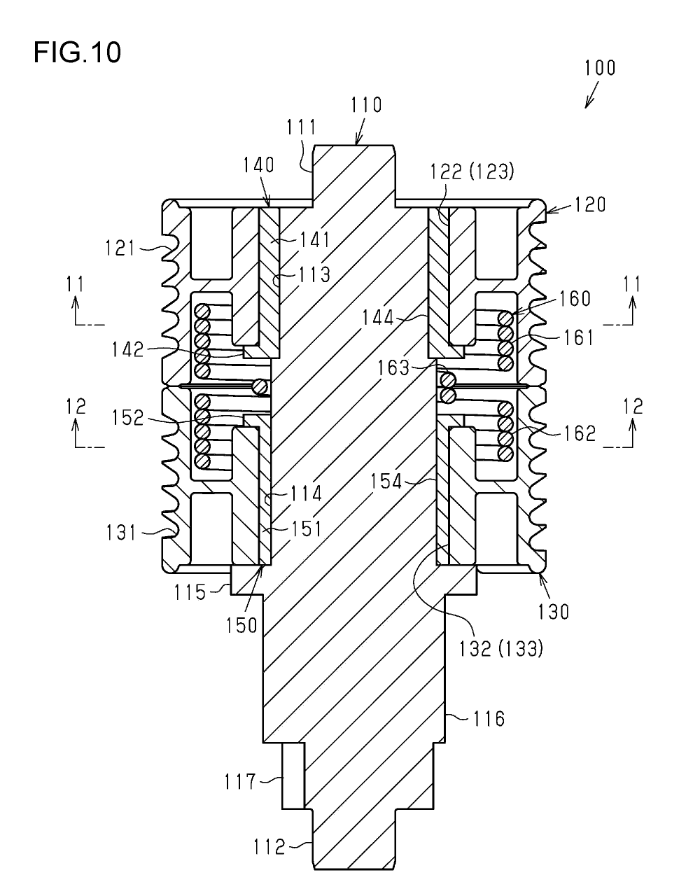

As illustrated in FIG. 9 and FIG. 10, the driven drum 100 includes a shaft 110, a first drum 120, a second drum 130, a first collar 140, a second collar 150, and a spring 160.

### Shaft 110

The shaft 110 includes two shaft sections 111, 112, a first engaging shaft section 113, a second engaging shaft section 114, a large-diameter shaft section 115, a shaft extension section 116, and a gear section 117. The two shaft sections 111, 112 serve as two ends in an axial direction of the shaft 110. Outer diameters of the two shaft sections 111, 112 are smaller than outer diameters of other sections of the shaft 110. The first engaging shaft section 113 is axially adjacent to the shaft section 111. A cross-sectional shape perpendicular to an axial direction of the first engaging shaft section 113 is non-circular. More specifically, the cross-sectional shape perpendicular to the axial direction of the first engaging shaft section 113 is oval-shaped. The second engaging shaft section 114 is axially adjacent to the first engaging shaft section 113. A cross-sectional shape perpendicular to an axial direction of the second engaging shaft section 114 is non-circular. More specifically, the cross-sectional shape perpendicular to the axial direction of the second engaging shaft section 114 is oval-shaped. An outer diameter of the second engaging shaft section 114 is slightly larger than that of the first engaging shaft section 113. The large-diameter shaft section 115 is disk-shaped. The large-diameter shaft section 115 is axially adjacent to the second engaging shaft section 114. An outer diameter of the large-diameter shaft section 115 is a section having the largest outer diameter in the shaft 110. The shaft extension section 116 is axially adjacent to the large-diameter shaft section 115. The gear section 117 is axially located between the large-diameter shaft section 115 and the shaft section 112.

### First Drum 120 and Second Drum 130

The first drum 120 is cylindrical. The first drum 120 includes a guide groove 121 and an engaging hole 122. The guide groove 121 is helical. The guide groove 121 is provided on an outer circumferential surface of the first drum 120. The engaging hole 122 penetrates through the first drum 120 in an axial direction of the first drum 120. The engaging hole 122 is non-circular when viewed in the axial direction. More specifically, an inner circumferential surface of the first drum 120 includes two first inner circumferential surfaces 123 and two second inner circumferential surfaces 124, all of which are perpendicular to a radial direction and four restraining faces 125 perpendicular to a circumferential direction. An inner diameter of the first inner circumferential surface 123 is smaller than that of the second inner circumferential surface 124. The two first inner circumferential surfaces 123 and the two second inner circumferential surfaces 124 are alternately arranged in the circumferential direction. The restraining face 125 radially connects the first inner circumferential surface 123 and the second inner circumferential surface 124, which are adjacent to each other in the circumferential direction.

The second drum 130 has a similar shape to the first drum 120. In other words, the second drum 130 includes a guide groove 131 that is equivalent to the guide groove 121 and an engaging hole 132 that is equivalent to the engaging hole 122. The engaging hole 132 is slightly larger than the engaging hole 122 of the first drum 120. Outer diameters of the first drum 120 and the second drum 130.are equal. In addition, an inner circumferential surface of the second drum 130 includes: two first inner circumferential surfaces 133 that are equivalent to the two first inner circumferential surfaces 123; two second inner circumferential surfaces 134 that are equivalent to the two second inner circumferential surfaces 124; and four restraining faces 135 that are equivalent to the four restraining faces 125.

An outer diameter of the driven drum 100, that is, an outer diameter of the first drum 120 and an outer diameter of the second drum 130 are larger than that of the drive drum 90. More specifically, a distance from an axis of the first drum 120 to a bottom surface of the guide groove 121 of the first drum 120 is larger than that from the axis of the drive drum 90 to a bottom surface of the guide groove 91 of the drive drum 90. Similarly, a distance from an axis of the second drum 130 to a bottom surface of the guide groove 131 of the second drum 130 is larger than that from the axis of the drive drum 90 to the bottom surface of the guide groove 91 of the drive drum 90.

### First Collar 140 and Second Collar 150

The first collar 140 includes a cylindrical section 141, two restraining ribs 142, and a flange 143. The cylindrical section 141 has a cylindrical shape. An outer diameter of the cylindrical section 141 is slightly smaller than an inner diameter of a section of the first drum 120 where the two first inner circumferential surfaces 123 are formed.

The cylindrical section 141 includes an insertion hole 144 that penetrates through the cylindrical section 141 in an axial direction. The insertion hole 144 is non-circular when viewed in the axial direction. A shape of the insertion hole 144 matches with a shape of the first engaging shaft section 113 of the shaft 110. The two restraining ribs 142 protrude outward in a radial direction of the cylindrical section 141 from an outer circumferential surface of the cylindrical section 141. Outer surfaces of the two restraining ribs 142 in the direction in which the ribs protrude are arc-shaped surfaces about an axis of the first collar 140. The two restraining ribs 142 are arranged at equal intervals in a circumferential direction of the first collar 140. An outer diameter of a section where the two restraining ribs 142 are provided is slightly larger than the inner diameter of a section of the first drum 120 where the first inner circumferential surfaces 123 are formed, and at the same time, slightly smaller than an inner diameter of a section of the first drum 120 where the second inner circumferential surfaces 124 are formed. A length in the circumferential direction of the restraining rib 142 is shorter than a length in the circumferential direction of the second inner circumferential surface 124 of the first drum 120. As an example, the length of the former is preferably approximately one third to a half of the length of the latter. In these respects, it can be said that an outer contour of the first collar 140 has a shape matching with the engaging hole 122 of the first drum 120. The flange 143 has a flange shape. The flange 143 spreads outward in the radial direction of the cylindrical section 141 at one end in the axial direction of the cylindrical section 141.

The second collar 150 has a similar configuration to the first collar 140. The second collar 150 includes a cylindrical section 151 that is equivalent to the cylindrical section 141, two restraining ribs 152 that are equivalent to the two restraining ribs 142, and a flange 153 that is equivalent to the flange 143. It should be noted that a shape of an insertion hole 154 that is equivalent to the insertion hole 144 matches with a shape of the second engaging shaft section 114 of the shaft 110. An outer contour of the second collar 150 has a shape matching with the engaging hole 132 of the second drum 130.

### Spring 160

The spring 160 is a torsion spring. The spring 160 includes a first coil 161, a second coil 162, an intermediate section 163, a first engaging portion 164, and a second engaging portion 165. The spring 160 is formed of a single wire rod. The first coil 161 and the second coil 162 are coiled. The first engaging portion 164 extends from a first end of the first coil 161 and the second engaging portion 165 extends from a first end of the second coil 162. The first engaging portion 164 and the second engaging portion 165 extend in an axial direction of the spring 160.

It should be noted that a direction in which the first engaging portion 164 extends is a direction opposite to a direction in which the second engaging portion 165 extends. The intermediate section 163 connects a second end of the first coil 161 and a second end of the second coil 162. The intermediate section 163 is wound in a rectangular shape when viewed in the axial direction. The spring 160 is equivalent to a “biasing member”.

### Engagement Relationship Among Components of Driven Drum 100

As illustrated in FIG. 9 to FIG. 12, the first engaging shaft section 113 and the second engaging shaft section 114 of the shaft 110 are respectively inserted into the insertion hole 144 of the first collar 140 and the insertion hole 154 of the second collar 150. The first collar 140 engages with the first engaging shaft section 113 of the shaft 110 and the second collar 150 engages with the second engaging shaft section 114 of the shaft 110. Thus, the first collar 140 and the second collar 150 can rotate in conjunction with the shaft 110. In other words, the first collar 140 and the second collar 150 cannot rotate relative to the shaft 110. The flange 143 of the first collar 140 is in contact with an end face of the second engaging shaft section 114 in the axial direction of the shaft 110. Consequently, a gap exists in the axial direction between the first collar 140 and the second collar 150.

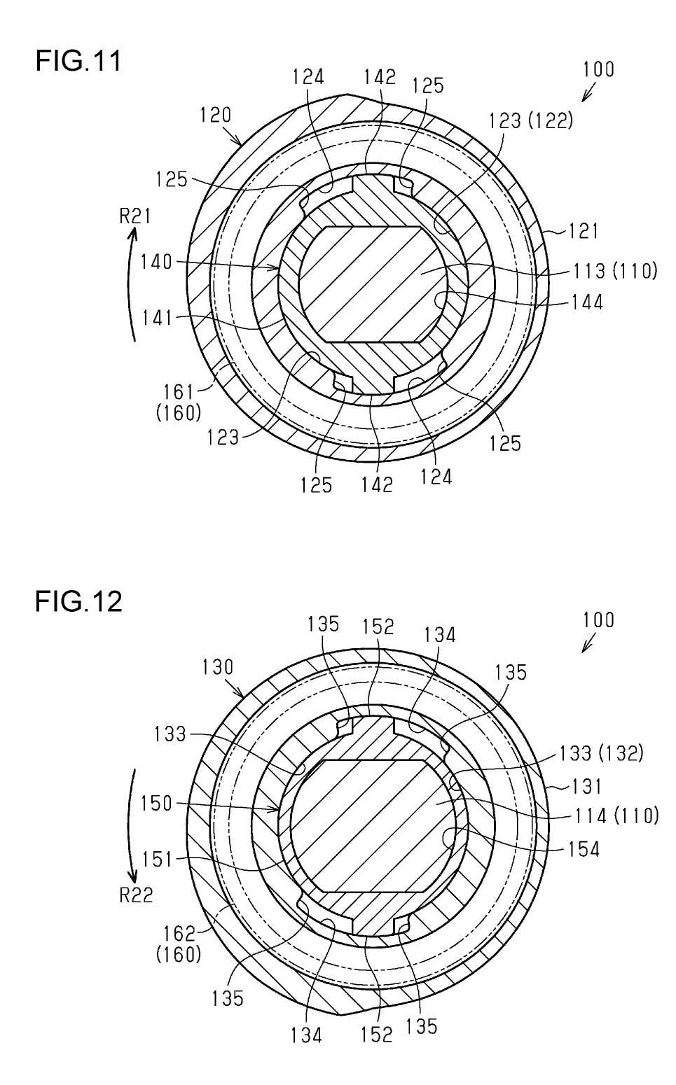

As illustrated in FIG. 10 and FIG. 11, the first collar 140 is inserted into the engaging hole 122 of the first drum 120. In this case, the two restraining ribs 142 of the first collar 140 individually face against the two second inner circumferential surfaces 124 of the first drum 120 in the radial direction. In addition, the restraining ribs 142 of the first collar 140 are located between the two restraining faces 125 of the first drum 120 in the circumferential direction. Thus, the first drum 120 can rotate relative to the first collar 140 within a range in which the restraining face 125 of the first drum 120 does not come into contact with the restraining rib 142 of the first collar 140. More specifically, the range in which the first drum 120 can rotate relative to the first collar 140 is an angular range equivalent to a difference obtained by subtracting the length of the restraining rib 142 in the circumferential direction of the first collar 140 from the length in the circumferential direction of the second inner circumferential surface 124 of the first drum 120.

As illustrated in FIG. 10 and FIG. 12, the second collar 150 is inserted into the engaging hole 132 of the second drum 130. In this case, the two restraining ribs 152 of the second collar 150 individually face against the two second inner circumferential surfaces 134 of the second drum 130 in the radial direction. In addition, the restraining ribs 152 of the second collar 150 are located between the two restraining faces 135 of the second drum 130 in the circumferential direction. Thus, the second drum 130 can rotate relative to the second collar 150 within a range in which the restraining face 135 of the second drum 130 does not come into contact with the restraining rib 152 of the second collar 150. More specifically, the range in which the second drum 130 can rotate relative to the second collar 150 is an angular range equivalent to a difference obtained by subtracting the length of the restraining rib 152 in a circumferential direction of the second collar 150 from the length in the circumferential direction of the second inner circumferential surface 134 of the second drum 130.

As illustrated in FIG. 10, the spring 160 is disposed in the axial direction between the first collar 140 and the second collar 150 and between the first drum 120 and the second drum 130. More specifically, the first coil 161 of the spring 160 is housed inside the first drum 120. The first engaging portion 164 of the spring 160 engages with the first drum 120. The second coil 162 of the spring 160 is housed inside the second drum 130. The second engaging portion 165 of the spring 160 engages with the second drum 130. The second engaging shaft section 114 of the shaft 110 is inserted into the intermediate section 163 of the spring 160. The intermediate section 163 of the spring 160 is disposed in the axial direction of the shaft 110 between the flange 143 of the first collar 140 and the flange 153 of the second collar 150.

The spring 160 is in an elastically deformed state about an axis of the shaft 110. Therefore, the spring 160 biases the first drum 120 and the second drum 130 in the circumferential direction. A direction in which the spring 160 biases the first drum 120 is opposite to a direction in which the spring 160 biases the second drum 130. More specifically, as illustrated in FIG. 11 and FIG. 12, the spring 160 biases the first drum 120 in a first driven direction R21 and at the same time, biases the second drum 130 in a second driven direction R22. In this case, the restraining face 125 of the first drum 120 is preferably not in contact with the restraining rib 142 of the first collar 140 in the circumferential direction. Similarly, the restraining face 135 of the second drum 130 is preferably not in contact with the restraining rib 152 of the second collar 150 in the circumferential direction.

As illustrated in FIG. 6 to FIG. 8, the shaft section 111 of the shaft 110 is rotatably supported by the second cover 76 and the shaft section 112 of the shaft 110 is rotatably supported by the second support plate 74. The shaft sections 111, 112 of the shaft 110 are preferably individually supported through a bearing by the second cover 76 and the second support plate 74 respectively. Thus, the driven drum 100 is rotatable about an axis that extends in the vertical direction. An axis of rotation of the driven drum 100 extends in such a way as to be positionally skewed to the axis of rotation of the drive drum 90.

### First Cable 171 and Second Cable 172

As illustrated in FIG. 6, the first cable 171 and the second cable 172 are cables for power transmission. Therefore, the first cable 171 and the second cable 172 are preferably formed of a material that has moderate elasticity in a bending direction and strength in a tensile direction. The first cable 171 is wound onto the drive drum 90 and the first drum 120 of the driven drum 100. The second cable 172 is wound onto the drive drum 90 and the second drum 130 of the driven drum 100. When the drive drum 90 rotates in the first driving direction R11, the first cable 171 is fed by the driven drum 100 and wound onto the drive drum 90. The second cable 172 is fed by the drive drum 90 and wound onto the driven drum 100. In this case, a rotation direction of the driven drum 100 is the second driven direction R22. On the other hand, when the drive drum 90 rotates in the second driving direction R12, the first cable 171 is fed by the drive drum 90 and wound onto the driven drum 100. The second cable 172 is fed by the driven drum 100 and wound onto the drive drum 90. In this case, the rotation direction of the driven drum 100 is the first driven direction R21.

As described above, the spring 160 of the driven drum 100 biases the first drum 120 in the first driven direction R21 and at the same time, biases the second drum 130 in the second driven direction R22. In other words, the spring 160 biases the first drum 120 in a direction in which the first drum 120 winds up the first cable 171 and at the same time, biases the second drum 130 in a direction in which the second drum 130 winds up the second cable 172.

### Intermediate Pulley 180

The intermediate pulley 180 includes a first pulley 181, a second pulley 182, and a pulley support shaft 183. The first pulley 181 and the second pulley 182 are rotatably supported by the pulley support shaft 183. The first pulley 181 and the second pulley 182 can rotate in opposite directions. As illustrated in FIG. 5 and FIG. 6, the first cable 171 is wound onto the first pulley 181 and the second cable 172 is wound onto the second pulley 182. One end of the pulley support shaft 183 is rotatably supported by the base 72 and the other end of the pulley support shaft 183 is rotatably supported by the second cover 76. The two ends of the pulley support shaft 183 are preferably individually supported through a bearing by the base 72 and the second cover 76 respectively. An axis of the pulley support shaft 183 extends in the width direction. In this respect, the axis of the pulley support shaft 183 extends in such a way as to be parallel to the axis of the drive drum 90. In contrast, the axis of the pulley support shaft 183 extends in such a way as to be positionally skewed to the axis of the driven drum 100.

### Transmission Unit 190

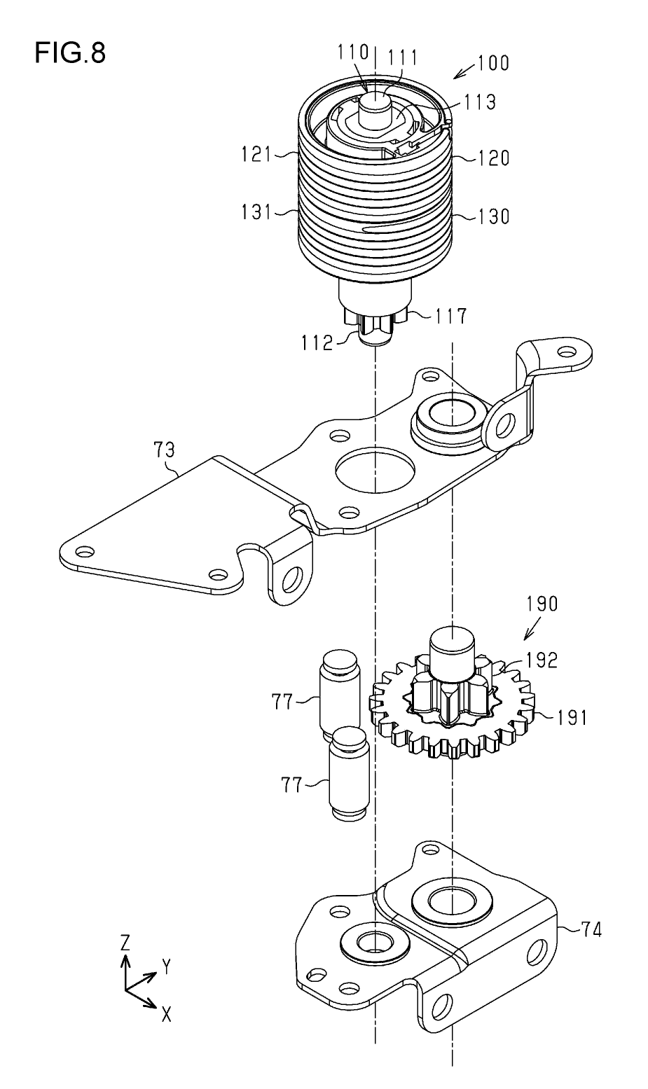

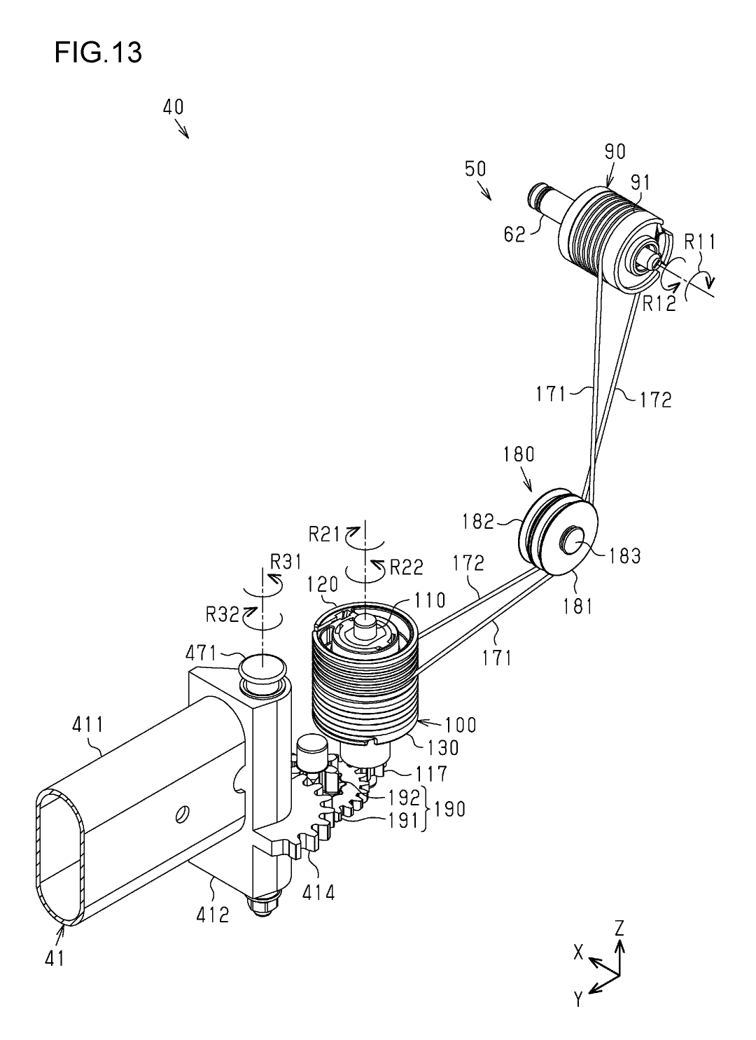

As illustrated in FIG. 8, the transmission unit 190 includes a first transmission gear 191 and a second transmission gear 192. The first transmission gear 191 and the second transmission gear 192 are configured in such a way as to rotate in an integrated manner. The number of teeth of the first transmission gear 191 is greater than that of the gear section 117 of the shaft 110. An upper end of the transmission unit 190 is rotatably supported by the first support plate 73 and a lower end of the transmission unit 190 is rotatably supported by the second support plate 74. The two ends of the transmission unit 190 are preferably individually supported through a bearing by the first support plate 73 and the second support plate 74 respectively. As illustrated in FIG. 13, the first transmission gear 191 meshes with the gear section 117 of the shaft 110 of the driven drum 100 and the second transmission gear 192 meshes with the output gear 414 of the first link arm 41. In this manner, the transmission unit 190 transmits power between the driven drum 100 and the first link arm 41. In other words, power is transmitted by the transmission unit 190 to the first link arm 41, and the first link arm 41 is provided with a torque for rotating the first link arm 41 about the axis of the first support shaft 471.

### Controller 200

The controller 200 is a processing circuit including a CPU and a read-only memory. The controller 200 controls the door drive unit 50 to open and close the door 30.

For example, the controller 200 receives a request to open or close the door 30 when a user operates a mobile device or a door handle. When the controller 200 receives a request to open the door 30, the controller 200 controls the door drive unit 50 to open the door 30. When the controller 200 receives a request to close the door 30, the controller 200 controls the door drive unit 50 to close the door 30.

### Operations in The Present Embodiment

Operations for opening and closing the door 30 will be described.

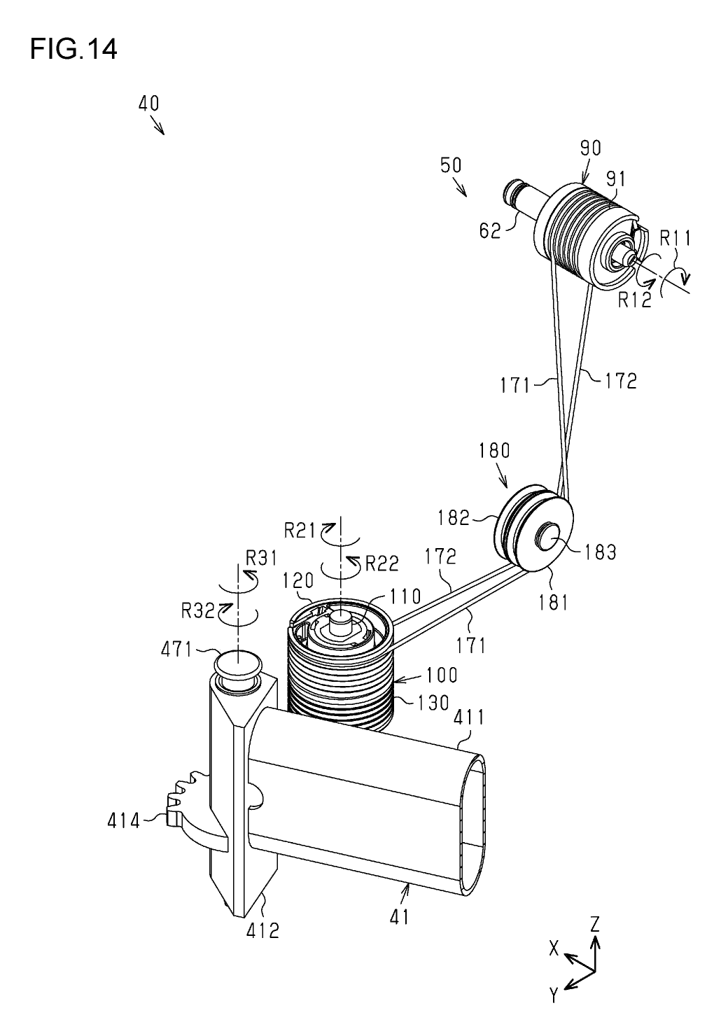

As illustrated in FIG. 1 and FIG. 13, to open the door 30 in a fully closed position, the drive drum 90 is driven by the actuator 60 in the first driving direction R11. The drive drum 90 then winds up the first cable 171 and the second cable 172 is fed by the drive drum 90. Meanwhile, the driven drum 100 winds up the second cable 172 and the first cable 171 is fed by the driven drum 100. Consequently, the driven drum 100 rotates in the second driven direction R22. When the driven drum 100 rotates in the second driven direction R22, power is transmitted from the gear section 117 of the driven drum 100 to the first transmission gear 191 of the transmission unit 190. Then, power is transmitted from the second transmission gear 192 of the transmission unit 190 to the output gear 414 of the first link arm 41. In this manner, the door drive unit 50 provides the first link arm 41 with a torque for rotating the first link arm 41 about the axis of the first support shaft 471 in a first rotation direction R31. Consequently, the first link arm 41 rotates in the first rotation direction R31, and the door 30 opens toward a fully open position. In other words, the door 30 operates from the fully closed position illustrated in FIG. 1 and FIG. 13 to the fully open position illustrated in FIG. 2 and FIG. 14.

As illustrated in FIG. 2 and FIG. 14, to close the door 30 in the fully open position, the drive drum 90 is driven by the actuator 60 in the second driving direction R12. The drive drum 90 then winds up the second cable 172 and the first cable 171 is fed by the drive drum 90. Meanwhile, the driven drum 100 winds up the first cable 171 and the second cable 172 is fed by the driven drum 100. Consequently, the driven drum 100 rotates in the first driven direction R21. When the driven drum 100 rotates in the first driven direction R21, power is transmitted from the gear section 117 of the driven drum 100 to the first transmission gear 191 of the transmission unit 190. Then, power is transmitted from the second transmission gear 192 of the transmission unit 190 to the output gear 414 of the first link arm 41. In this manner, the door drive unit 50 provides the first link arm 41 with a torque for rotating the first link arm 41 about the axis of the first support shaft 471 in a second rotation direction R32. Consequently, the first link arm 41 rotates in the second rotation direction R32, and the door 30 closes toward the fully closed position. In other words, the door 30 operates from the fully open position illustrated in FIG. 2 and FIG. 14 to the fully closed position illustrated in FIG. 1 and FIG. 13.

### Advantageous Effects of The Present Embodiment

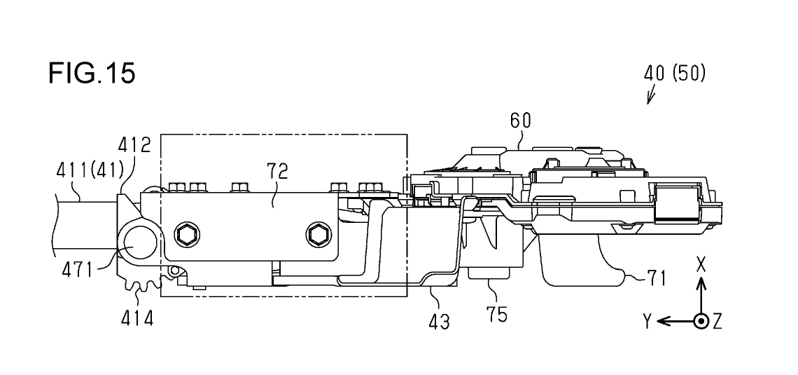

(1) As an example, a comparative example is considered in which the actuator 60 directly drives the driven drum 100. In this case, when the axis of the output shaft 62 of the actuator 60 coincides with the axis of the driven drum 100, the actuator 60 is disposed in a region indicated by a long-dashed double-dotted line illustrated in FIG. 15. Then, a space occupied in the width direction by the door opening and closing device of the comparative example becomes large. In other words, in the door opening and closing device of the comparative example, an amount of overhang of the actuator 60 with respect to a vehicle interior becomes large.

Compared to this comparative example, the door opening and closing device 40 transmits power through the drive drum 90 and the driven drum 100 and the cables 171, 172 from the actuator 60 to the output gear 414 of the first link arm 41. Therefore, in the door opening and closing device 40, the driven drum 100 and the transmission unit 190 can be disposed near the first link arm 41 while the actuator 60 and the drive drum 90 can be disposed at a distance from the first link arm 41. Thus, the door opening and closing device 40 can increase degrees of freedom in disposing the door drive unit 50. Consequently, the door opening and closing device 40 can restrict the amount of overhang thereof with respect to the vehicle interior when the door 30 is positioned in the fully closed position. In other words, the door opening and closing device 40 can enlarge a residential space in the vehicle 10 in the width direction, or enlarge a trunk in the width direction.

(2) In the door opening and closing device 40, the outer diameter of the driven drum 100 is larger than that of the drive drum 90. Therefore, the door opening and closing device 40 can reduce a rotational speed of the driven drum 100 compared to that of the drive drum 90. Consequently, when a component for reducing the rotational speed is disposed between the driven drum 100 and the transmission unit 190, the door opening and closing device 40 can reduce a size of the component. More specifically, the door opening and closing device 40 can reduce the numbers of teeth of the gear section 117 of the shaft 110 of the driven drum 100 and the gears constituting the transmission unit 190.

(3) For example, to adjust slack of the cables 171, 172 disposed between the drive drum 90 and the driven drum 100 with a tensioner, a space for providing the tensioner needs to be secured between the drive drum 90 and the driven drum 100. Compared to this, in the door opening and closing device 40 according to the embodiment described above, a component part serving as the “tensioner” is built into the driven drum 100. Therefore, the door opening and closing device 40 does not need the space for the tensioner to be secured between the drive drum 90 and the driven drum 100.

(4) The driven drum 100 includes the first drum 120 onto which the first cable 171 is wound, the second drum 130 onto which the second cable 172 is wound, and the spring 160 that biases the first drum 120 in the direction in which the first drum 120 winds up the first cable 171 and at the same time, biases the second drum 130 in the direction in which the second drum 130 winds up the second cable 172. Therefore, the door opening and closing device 40 can achieve the tensioner for taking up the slack of the first cable 171 and the second cable 172 with a simple configuration. In addition, the spring 160 is housed inside the first drum 120 and the second drum 130. In this respect, the door opening and closing device 40 can prevent the tensioner from coming into contact with a structure around the driven drum 100.

(5) A comparative example is considered in which “the drive drum 90, the intermediate pulley 180, the driven drum 100, and the cables 171, 172” of the door opening and closing device 40 are substituted with “a drive pulley, an intermediate pulley, a driven pulley, and a belt”. In this comparative example, since power is transmitted by the belt, an effect of misalignment of a position of the drive pulley, a position of the intermediate pulley, and a position of the driven pulley in the width direction on power transmission efficiency is likely to become great. Such a tendency is likely to become more prominent when using a toothed belt and a toothed pulley. Compared to this, since power is transmitted by the cables 171, 172 in the present embodiment, an effect of misalignment of the position of the drive drum 90, the position of the intermediate pulley 180, and the position of the driven drum 100 in the width direction on power transmission efficiency is small. Thus, the door opening and closing device 40 can increase degrees of freedom in disposing the drive drum 90, the intermediate pulley 180, the driven drum 100 in the width direction.

(6) The first vehicle-body side bracket 43 rotatably supports the proximal side connecting section 412 of the first link arm 41 through the first support shaft 471. In this case, the first support shaft 471 penetrates through the proximal side connecting section 412 of the first link arm 41 in the vertical direction. This enhances rigidity of a structure in which the proximal side connecting section 412 of the first link arm 41 is rotatably supported.

### Variation Examples

The present embodiment may be modified and implemented as follows. The present embodiment and the following variation examples may be implemented in combination as long as they are technically consistent.

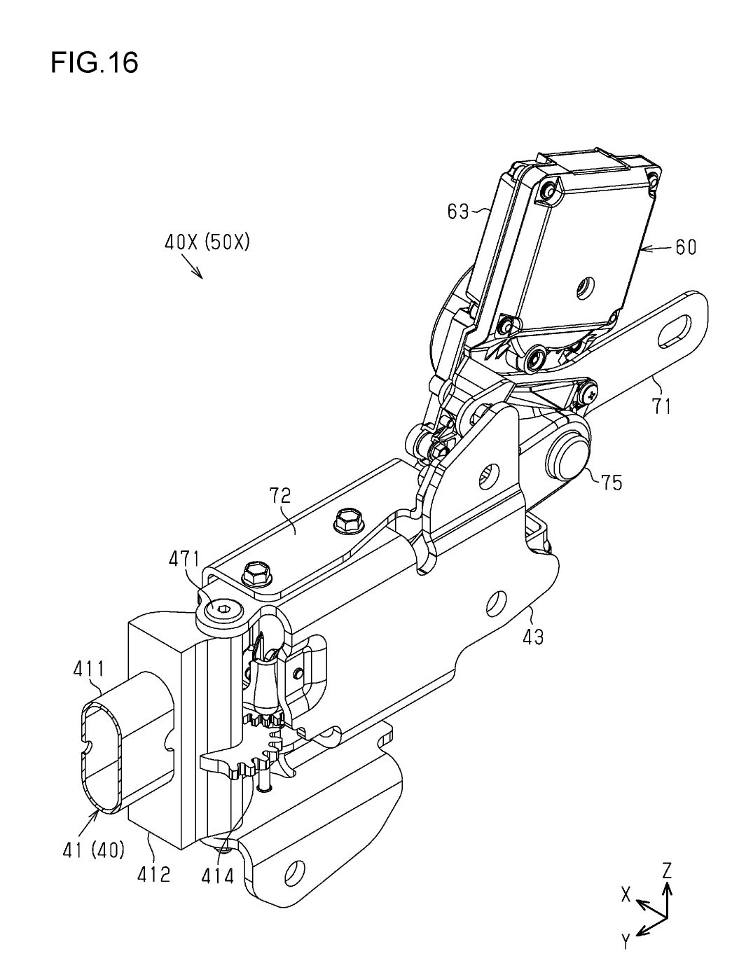

Referring to FIG. 16 to FIG. 18, a door opening and closing device 40X according to a variation example will be described. Comparing the door opening and closing device 40X according to the variation example with the door opening and closing device 40 according to the embodiment described above, the door opening and closing device 40X is roughly the same as the door opening and closing device 40 except that the intermediate pulley 180 is not included and the positional relation between the drive drum 90 and the driven drum 100 is different. Therefore, in the description below, components in the variation example that have the same function as those in the embodiment described above are assigned with the same reference signs and descriptions thereof are omitted.

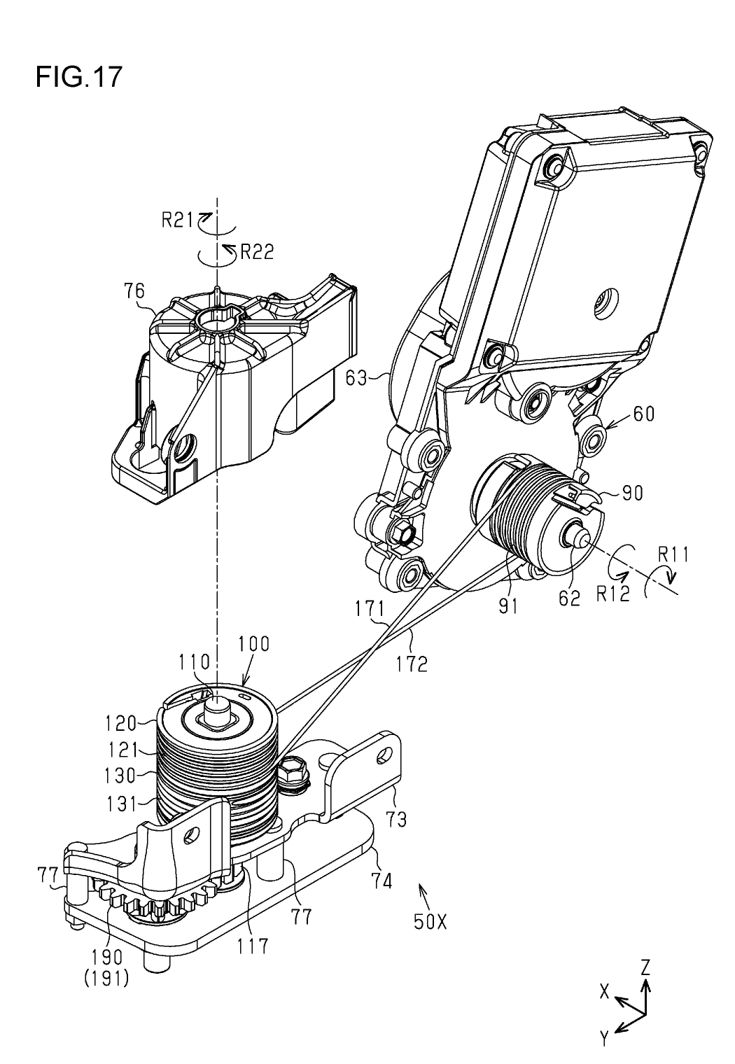

As illustrated in FIG. 16 and FIG. 17, the door opening and closing device 40X includes a door drive unit 50X. The door drive unit 50X includes the actuator 60, the actuator bracket 71, the base 72, the first cover 75, the second cover 76, the first support plate 73, the second support plate 74, a plurality of the connecting shafts 77, the drive drum 90, the driven drum 100, the two cables 171, 172, and the transmission unit 190. In other words, the door drive unit 50X does not include the intermediate pulley 180.

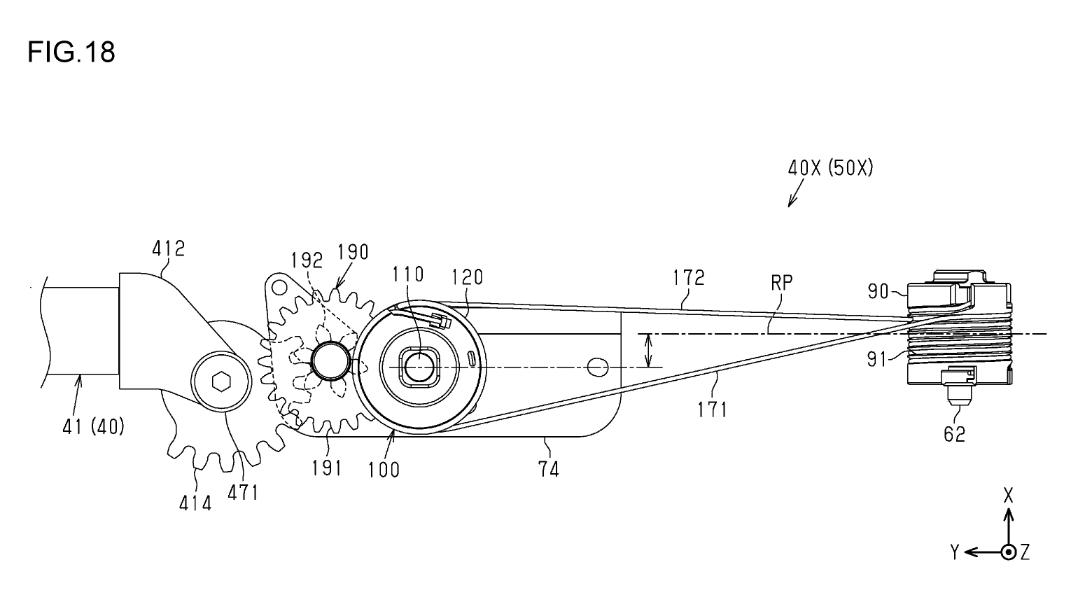

In the variation example, the actuator 60 is disposed lower than in the embodiment described above. In this respect, the distance in the vertical direction between the axis of rotation of the drive drum 90 and the axis of rotation of the driven drum 100 is shorter than in the embodiment described above. Similarly to the embodiment described above, the axis of rotation of the drive drum 90 extends in such a way as to be positionally skewed to the axis of rotation of the driven drum 100. As illustrated in FIG. 18, a plane is defined as a reference plane RP for the drive drum 90, the plane being perpendicular to the axis of rotation of the drive drum 90 and passing through the center of the drive drum 90 in the axial direction within a section where the guide groove 91 of the drive drum 90 is formed. In the width direction, the reference plane RP for the drive drum 90 is located off the axis of rotation of the driven drum 100. In the variation example, the reference plane RP for the drive drum 90 is located inward in the width direction relative to the axis of rotation of the driven drum 100. In another variation example, the reference plane RP for the drive drum 90 may be located outward in the width direction relative to the axis of rotation of the driven drum 100. In these respects, it can be said that the drive drum 90 is located off the axis of rotation of the driven drum 100 in the width direction.

The first cable 171 is wound onto the drive drum 90 and the first drum 120 of the driven drum 100. The second cable 172 is wound onto the drive drum 90 and the second drum 130 of the driven drum 100. The first cable 171 and the second cable 172 are wound onto the drive drum 90 and the driven drum 100 without the intermediate pulley 180 in between. In other words, the first cable 171 and the second cable 172 extend linearly between the drive drum 90 and the driven drum 100.

The variation example illustrated in FIG. 16 to FIG. 18 can achieve an effect equivalent to that in the embodiment described above. In the variation example, since the intermediate pulley 180 is not included, the drive drum 90 and the driven drum 100 may be disposed closer to each other. Consequently, the variation example can prevent a size of the device from becoming larger in the vertical direction and shorten lengths of the first cable 171 and the second cable 172. Further, depending on the vehicle 10 in which the door opening and closing device 40X is mounted, by locating the drive drum 90 and the driven drum 100 with an offset in the width direction, a space for mounting the door opening and closing device 40X in the vehicle 10 can be efficiently utilized.

In the variation example described above, the reference plane RP for the drive drum 90 may overlap with the axis of rotation of the driven drum 100 in the width direction. In other words, the drive drum 90 does not have to be located off the axis of rotation of the driven drum 100 in the width direction.

The door drive unit 50 may provide a torque to the proximal portion of the first link arm 41 or the distal portion of the first link arm 41.

A component corresponding to the “tensioner” may be built into the drive drum 90, not into the driven drum 100. The component corresponding to the “tensioner” may be built into both the drive drum 90 and the driven drum 100.

The door drive unit 50 does not have to include the component corresponding to the “tensioner”. In this case, the driven drum 100 is preferably constructed of a single member as in the drive drum 90.

A diameter of the drive drum 90 may be equal to or smaller than that of the driven drum 100.

In the driven drum 100, the spring 160 may be divided into a spring that biases the first drum 120 and a spring that biases the second drum 130.

In the driven drum 100, the spring 160 just has to be configured in such a way that the spring 160 can bias the first drum 120 and the second drum 130. For example, the spring 160 may be substituted with an elastic body such as rubber.

The first cable 171 and the second cable 172 may be integrated into a single cable. For example, an end of the first cable 171 and an end of the second cable 172, both ends being engaged to the drive drum 90 may be connected.

The door opening and closing device 40 may include a plurality of the intermediate pulleys 180 in the course that the first cable 171 and the second cable 172 follow between the drive drum 90 and the driven drum 100.

The drive drum 90 may be or does not have to be located off the axis of rotation of the driven drum 100. Such an offset is preferably appropriately provided according to the space for mounting the door opening and closing device 40 in the vehicle 10.

The door opening and closing device 40 may include a tensioner that takes up the slack of the first cable 171 disposed between the drive drum 90 and the driven drum 100 by pushing the first cable 171 in a direction intersecting with the direction in which the first cable 171 extends. The door opening and closing device 40 may include a tensioner that takes up the slack of the second cable 172 by means of the same method.

The transmission unit 190 just has to be configured in such a way that the transmission unit 190 can transmit power from the driven drum 100 to the first link arm 41. For example, the transmission unit 190 may be a drive arm that is rotated by the power transmitted from the driven drum 100. In this case, the drive arm preferably provides, by rotating, the first link arm 41 with a torque for rotating the first link arm 41 about the axis of the first support shaft 471.

In the embodiment described above, the door opening and closing device 40 is applied to a rear door of the vehicle 10, but the door opening and closing device 40 may be applied to a front door of the vehicle 10 in the variation example.

### Summary of The Present Embodiment

A vehicle door opening and closing device is a vehicle door opening and closing device to be applied to a vehicle including a vehicle body having a door opening and a door that opens and closes the door opening, and includes: a link arm with a proximal portion rotatably connected to the vehicle body and a distal portion rotatably connected to the door; and a door drive unit that provides the link arm with a torque for rotating the link arm relative to the vehicle body. The door drive unit includes: a drive drum to be driven by an electric motor; a driven drum to be disposed at a distance from the drive drum; a cable that is wound onto the drive drum and the driven drum and transmits power from the drive drum to the driven drum; and a transmission unit that provides the link arm with the torque, based on power transmitted from the driven drum.

The vehicle door opening and closing device transmits power through the drive drum, the driven drum, and the cable from the electric motor to the transmission unit. Therefore, in the vehicle door opening and closing device, the driven drum and the transmission unit can be disposed near the link arm while the drive drum and the electric motor can be disposed far from the link arm. Thus, the vehicle door opening and closing device can increase a degree of freedom in disposing components of the door drive unit.

In the vehicle door opening and closing device, a diameter of the drive drum may be smaller than that of the driven drum.

The vehicle door opening and closing device can reduce a rotational speed of the driven drum to a level lower than that of the drive drum when power is transmitted from the drive drum to the driven drum. Consequently, when a component for reducing the rotational speed is disposed between the driven drum and the transmission unit, the vehicle door opening and closing device can reduce a size of the component. When a sufficient reduction ratio can be secured, the vehicle door opening and closing device does not need to include the component for reducing the rotational speed between the driven drum and the transmission unit.

In the vehicle door opening and closing device, the door drive unit may include a tensioner for adjusting slack of the cable, and the tensioner may be built into at least one of the drive drum and the driven drum.

When adjusting the slack of the cable disposed between the drive drum and the driven drum with the tensioner, a space for providing the tensioner needs to be secured between the drive drum and the driven drum. In this respect, in the vehicle door opening and closing device having the configuration described above, since the tensioner is built into at least one of the drive drum and the driven drum, the space for providing the tensioner does not need to be secured between the drive drum and the driven drum.

In the vehicle door opening and closing device, the driven drum may include a first drum and a second drum that are arranged in a direction in which an axis of rotation of the driven drum extends and onto which the cable is wound; when the driven drum rotates in a first driven direction, the first drum may wind up the cable and the cable may be fed by the second drum; when the driven drum rotates in a second driven direction being a direction opposite to the first driven direction, the cable may be fed by the first drum and the second drum may wind up the cable; and the tensioner may include a biasing member that biases the first drum in the first driven direction and at the same time, biases the second drum in the second driven direction.

The vehicle door opening and closing device can achieve the tensioner to be built into the driven drum with a simple configuration.

In the vehicle door opening and closing device, an axis of rotation of the drive drum may extend in such a way as to be positionally skewed to an axis of rotation of the driven drum, and the drive drum may be located off the axis of rotation of the driven drum in a width direction of the vehicle.

Depending on a vehicle in which the vehicle door opening and closing device is mounted, by locating the drive drum and the driven drum with an offset in the width direction, a space for mounting the vehicle door opening and closing device in the vehicle can be efficiently utilized.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A vehicle door opening and closing device to be applied to a vehicle including a vehicle body having a door opening and a door that opens and closes the door opening, the vehicle door opening and closing device comprising:
a link arm with a proximal portion to be rotatably connected to the vehicle body and a distal portion to be rotatably connected to the door; and
a door drive unit that provides the link arm with a torque for rotating the link arm relative to the vehicle body, wherein
the door drive unit includes:
a drive drum to be driven by an electric motor;
a driven drum to be disposed at a distance from the drive drum;
a cable that is wound onto the drive drum and the driven drum and transmits power from the drive drum to the driven drum; and
a transmission unit that provides the link arm with the torque, based on power transmitted from the driven drum.

2. The vehicle door opening and closing device according to claim 1, wherein a diameter of the drive drum is smaller than that of the driven drum.

3. The vehicle door opening and closing device according to claim 1, wherein
the door drive unit includes a tensioner for adjusting slack of the cable, and
the tensioner is built into at least one of the drive drum and the driven drum.

4. The vehicle door opening and closing device according to claim 2, wherein
the door drive unit includes a tensioner for adjusting slack of the cable, and
the tensioner is built into at least one of the drive drum and the driven drum.

5. The vehicle door opening and closing device according to claim 3, wherein
the driven drum includes a first drum and a second drum that are arranged in a direction in which an axis of rotation of the driven drum extends and onto which the cable is wound,
when the driven drum rotates in a first driven direction, the first drum winds up the cable and the cable is fed by the second drum, and when the driven drum rotates in a second driven direction being a direction opposite to the first driven direction, the cable is fed by the first drum and the second drum winds up the cable, and
the tensioner includes a biasing member that biases the first drum in the first driven direction and at the same time, biases the second drum in the second driven direction.

6. The vehicle door opening and closing device according to claim 4, wherein
the driven drum includes a first drum and a second drum that are arranged in a direction in which an axis of rotation of the driven drum extends and onto which the cable is wound,
when the driven drum rotates in a first driven direction, the first drum winds up the cable and the cable is fed by the second drum, and when the driven drum rotates in a second driven direction being a direction opposite to the first driven direction, the cable is fed by the first drum and the second drum winds up the cable, and
the tensioner includes a biasing member that biases the first drum in the first driven direction and at the same time, biases the second drum in the second driven direction.

7. The vehicle door opening and closing device according to claim 1, wherein
an axis of rotation of the drive drum extends in such a way as to be positionally skewed to an axis of rotation of the driven drum, and
the drive drum is located off the axis of rotation of the driven drum in a width direction of the vehicle.
